(19) United States
(12) Patent Application Publication
(10) Pub. No.: US 2006/0294392 A1
(43) Pub. Date: Dec. 28, 2006

(54) Protection of a password-based user authentication in presence of a foe

(75) Inventors: Peter Veprek, San Jose, CA (US); Phillippe Morin, Goleta, CA (US)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/169,166

(22) Filed: Jun. 28, 2005

(51) Int. Cl. H04L 9/00

(52) U.S. Cl. 713/183

(57) ABSTRACT

A user authentication method includes receiving a transformed password, determining a password based on the transformed password, making a comparison between the transformed password and a record of at least one previously received transformed password, and determining whether to authenticate a user based on the password and results of the comparison.

### FIELD OF THE INVENTION

The present invention generally relates to user authentication systems, and relates in particular to protection of a password during entry of the password into a password-based user authentication system.

### BACKGROUND OF THE INVENTION

For normal levels of security, the most common technique used to authorize access to data, services, or premises is the use of a password. The length and quality of the password determine its strength. Short or easily guessable passwords provide only low protection. For higher levels of security, other techniques such as fingerprint, voiceprint, irisprint, or others can be used. These applications, however, are rather rare in comparison.

On the other hand, applications of password-based access are abundant. In fact most of today's applications requiring a normal level of security use passwords. These applications include mainframe/personal computers, office/house/car doors, cell phones, automatic teller machines, numerous Internet/telephone-based services, alarm systems, parental control (TV, VCR/DVD, PC etc.), and many others.

Password-based protection is usually sufficient provided the password is strong enough and it cannot be intercepted by foes. To prevent easy interception, passwords are typically not echoed (i.e. not displayed, spoken, or otherwise indicated) back to the user, are transmitted in an encrypted form, and are not stored. Besides low-strength passwords mentioned earlier, typically the most common reason for breach of security is the user's actions, such as writing the password down and leaving it accessible. Assuming the strength of the password is sufficient and the user is cooperative in the sense of taking the necessary precautions and not revealing the password, the next considerable weakness of password-based protection is the fact that, even though the password is not echoed back to the user, an occasional foe can learn the password by monitoring the user when the user inputs it.

There are several remedies available to protect password-based access against foes in this case. The protection techniques that can be used include providing a secure way of inputting the password (i.e., ensuring privacy while inputting the password), forcing change of the password at regular intervals, and the use of other, usually time-varying, input to supplement the password. The time-varying input can be, for example, a numeric code generated by a device where the code is changing in time and the device code generation is synchronized to the main access authorization system to ensure correct functionality (e.g. a SecureID card). Alternatively, the password can be supplemented by a biometric feature such as a voiceprint (e.g., the password can be spoken—input by voice). In all these cases, authentication uses the following elements: what the user knows (i.e., password) with what the user has (i.e., device) and/or who the user is (i.e., biometrics).

Yet, the typical cures to password interception described above typically fail to prevent acquisition of the password by an interloper during entry by the user. Instead, they either require a supplement, such as a physical device or a user biometric, or else try to cure the interception by changing the password. Those cures that do attempt to thwart password interception generally rely on providing a secure environment for the password entry. However, it is not always possible to provide such a secure environment, and resourceful interlopers can often overcome secure environments.

What is needed is a way to prevent an interloper from determining a password even when the interloper is able to observe entry of the password. The present invention fulfills this need.

### SUMMARY OF THE INVENTION

In accordance with the present invention, a user authentication method includes receiving a transformed password, determining a password based on the transformed password, making a comparison between the transformed password and a record of at least one previously received transformed password, and determining whether to authenticate a user based on the password and results of the comparison.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flow diagram illustrating a user authentication method in accordance with the present invention;

FIG. 2 is a functional block diagram illustrating a user authentication system in accordance with the present invention;

FIGS. 3A-3C is a set of views illustrating sequential spatial transformations of a user PIN on a user interface region;

FIG. 4 is a functional block diagram illustrating a user authentication system in accordance with the present invention; and

FIGS. 5A-5C is a set of views illustrating sequential spatial transformations of a randomly padded user PIN, and a related detransformation table.

### DETAILED DESCRIPTION OF THE PREFERRED EMBODIMENTS

The following description of the preferred embodiments is merely exemplary in nature and is in no way intended to limit the invention, its application, or uses.

The present invention proposes a novel, secure method for entering a password in vulnerable conditions by applying one-time transformation of the password (e.g., hiding the password in a noisy string).

The following solution is proposed to protect a password, P, from being observed by a foe at the time the user inputs it into the authentication system. When needed, the user does not input the password, P, itself but rather its one-time transformed version, Ti(P). The transformation Ti(.) shall be such that Ti(P) does not reveal P (i.e., the probability of deducing the password P from Ti(P), p(P|Ti(P)), is very small (p(P|Ti(P))<<1) and, preferably, adjustable. In addition, Ti(P) should satisfy the condition that, given a transformed version of the password Ti(P), the probability of generating a different valid transformation of the password Tj(P) is also negligible (p(Tj(P)|Ti(P))<<1, j≠i). This condition is further combined as follows. During operation, the authentication system can accept either P or a valid Ti(P) to authenticate the user. Repeated use of the same Ti(P) or Tj(P) that is similar to Ti(P), however, is prohibited either forever, or until a one or more predetermined conditions are met, such as passage of time, a sufficient number of valid authentications, etc. By similar, any (trivial) modification of Ti(P) is denoted as similar, where similarity can be measured, for example, by dynamically aligning Tj(P) with Ti(P) and counting the number of differences (e.g., insertions, substitutions and omissions).

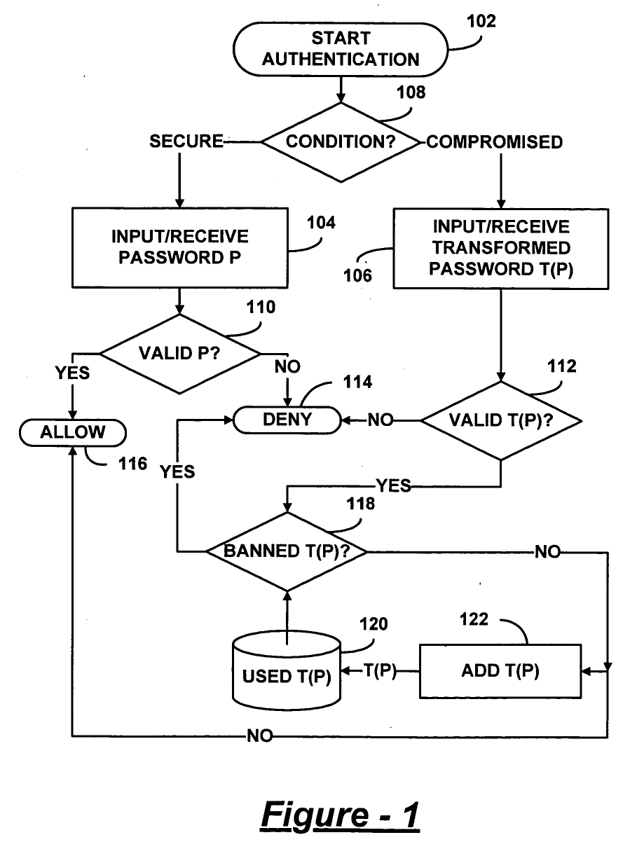

Referring to FIG. 1, the method according to the present invention begins at the start of authentication 102, with the user inputting either the password P at step 104 or an allowed transformation of the password T(P) at step 106, depending on whether the user is in secure or compromised conditions as at 108. The start of authentication 102 can include prompting the user to enter the password, so that the user input is in response to a prompt for a user password. If the user input is determined to be neither the password P nor an allowed transformation of the password T(P) at decision steps 110 and 112, respectively, then the user is denied access at 114. However, if the user input is identified as the password at step 110, then the user is allowed access at 116.

Yet, if the input is determined to be an allowed transformation at step 112, then it is further determined if the allowed transformation is one that is currently banned at decision step 118. It should be readily understood that an allowed transformation is one that follows a predetermined transformation rule, while a banned transformation is one that follows the rule, but has been at least temporarily banned as a result of previous use of the transformation or similarity to a previously used transformation. Thus, a banned transformation should not be confused with a disallowed transformation. The predetermined transformation rule can be selected by the user or the authentication system from a list of possible transformation rules.

Determination of whether the allowed transformation is currently banned involves comparison of the allowed transformation and previously received allowed transformations recorded in used transformations datastore 120. If the transformation is determined to be banned at step 118, then the user is denied access at 114. However, if the transformation is not banned, then the user is allowed access at 116, and the recently received allowed transformation is added by module 122 to datastore 120; thus, the allowed transformation becomes banned, at least temporarily. Denial and allowance of user access at 114 and 116 result from respective decisions whether to authenticate the user.

The present invention can be more fully understood by the following illustration. The following example illustrates some embodiments of the present invention. However, it is envisioned that other embodiments of the invention can employ different transformation techniques, and can determine similarity between new and previous transformations in different ways and to different degrees.

In this example, consider a 4-digit PIN as a password:

4-digit PIN: DDDD

where D=(0 . . . 9).

Let the password be 2005.

Chances of guessing the password in a single attempt are 1 in 10,000 (i.e., 0.01%). Under a secure condition, the password can be input directly (i.e., 2005 in this case). If, however, the area or circumstances are compromised, the user can input a transformed version of the password instead of the password itself. The purpose of this transformation is to disguise the password from a possible foe. The authentication system is able to validate a user when either the user's password or its transformed version is input by the user. However, once a particular transformed version of the password is used to authenticate the user, it, together with its simple derivations, is blocked for future use either permanently, for some period of time, or until one or more predetermined conditions are met (to prevent a foe from using it).

As an example password transformation, let the transformation be: “padding of the PIN with (random) digits to the length of 8 digits” and let the PIN be: “2005”. Therefore, in this case the user could input 82080425 to gain access. The chances of guessing a transformation of the password by inputting a random 8-digit PIN are 502,435 in 100,000,000 i.e. ˜0.5%. The chances of inferring the password based on its transformed version are, in this case, 1 in 70 i.e. 1.4%.

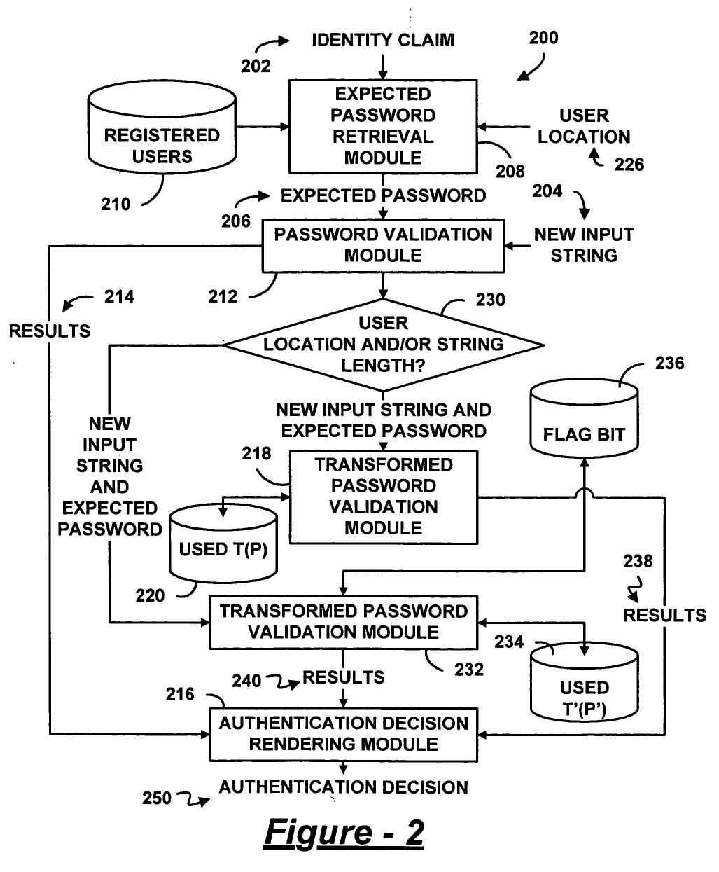

Turning now to FIG. 2, the authentication system 200, upon receipt of a claimed user identity 202, such as an ATM card number, and a new input string 204, such as a PIN or transformed PIN, can first determine an expected password 206 (i.e., PIN) based on the claimed user identity 202. Accordingly, expected password retrieval module 208 can look up a PIN stored in memory 210 for a registered user identity matching the claimed user identity 202. Then, password validation module 212 can determine if the new input string 204 matches the expected password 206, and communicate the result 214 to authentication decision rendering module 216.

Next, transformed password validation module 218 can look for the expected password 206 in the new input string 204 by beginning at the leftmost side of the input string 204 and scanning right while looking for the first digit, ‘2’, of the expected password 206. Upon finding the ‘2’, the module 218 can continue scanning right while looking for the next digit, ‘0’, of the expected password 206. Processing of the new input string 204 can continue in this manner until every digit of the expected password 206 is successfully found, or until the end of the new input string 204 is reached. If all of the expected digits are located in the proper order, then the expected password 206 is successfully determined to be present in the new input string 204. However, the new input string 206 must pass a further test in order for the user to be authenticated.

Before, after, or concurrently with the determination of the expected password 206 based on the new input string 204, the authentication system 200 also compares the new input string 204 to a record of one or more previously received input strings stored in memory 220. For example, the new input string 204 can be compared to each previously recorded input string to assess similarity. If the new input string 204 is too similar, then the user is not authenticated, even if the expected password 206 is successfully determined to be present in the new input string 204. Module 218 outputs results 238 of its analyses to module 216.

In assessing similarity, the authentication system 200 may require that at least three digits of the new input string 204 be different from each previously recorded input string in memory 220. For example, the system can initialize a reference count variable to zero, and then compare the first (i.e., leftmost) digit of the new string 204 to the first digit of a previously recorded input string in memory 220. If the digits are not identical, then a reference count variable can be incremented. In subsequent iterations, subsequent digits of the new and recorded strings can be compared and the reference count variable conditionally incremented. Between iterations or after all iterations, the reference count variable can be compared to a predetermined threshold, such as two. If the reference count variable equals or alternatively exceeds the threshold, then the previously recorded string can be deemed sufficiently dissimilar, and the process can continue with assessment of similarity between the new string and a next previously recorded string. However, once a previously recorded string is fully assessed and the reference count has not risen to a sufficient degree, then similarity is found and the user is not authenticated. Yet, if all of the recorded input strings are assessed and none are found to be too similar to the new input string, then the user can be authenticated, and the new input string 204 added to the record of previously recorded input strings. Thus, the transformed version of the PIN (82080425) and its simple derivations are disallowed for future use, at least temporarily. It is envisioned that an alternative or additional similarity assessment technique can include forcing that at least two of the PIN's digits be placed at a different position.

It is envisioned that similarity assessment can be handled in various ways. For example, the system 200 can generate simple derivations of the new input string 204 and compare each derivation to each previously recorded input string for identity. Alternatively, the system can generate simple derivations of input strings and add them to the record of previously recorded input strings, testing newly received input strings against the record contents of memory 220 for identity. It should be readily apparent that other ways of transforming passwords can be employed, and that password determination and similarity assessment can vary accordingly. Thus, various further alternatives will be readily apparent to those skilled in the art.

In some embodiments, the system 200 can be adapted to accommodate non-conforming equipment in various ways. For example, consider the case in which a banking institution employs system 200 at its central server to authenticate users of Automatic Teller Machines (ATMs). The bank can adapt most or all of its ATMs to accept input strings of eight characters in length from a user in response to a prompt for the user's PIN. However, the ATMs of other banking institutions may not be so adapted, and may restrict the user to entering a string of four characters.

When the user is forced to enter exactly four digits, then the user may still employ the four digit PIN when using the ATMs of other banking institutions. However, the user's banking institution can also allow the user employing the ATM of another bank to input a four digit transformation of a two digit PIN. The two digit PIN can be, for example, the last two digits, 05, of the usual four digit PIN, 2005. Accordingly, the user may input either the entire PIN, 2005, or an allowed, four digit transformation (e.g., 0725) of the smaller PIN, 05. In this case, the chances of guessing an allowed PIN are one in one-hundred, instead of the usual one in ten-thousand. Also, the chances of inferring an allowed PIN from an observed PIN are only reduced to one in six. However, when combined with a banking institution's practice of disabling account access following a given number of failed authorization attempts, benefits can still be obtained even with a four digit transformation of a two-digit pin.

As an added level of security, the banking institution can initially attempt to authenticate the user based on a four digit string received from another bank's ATM by looking for the user's four digit PIN in the usual manner at module 214. Then based on the length of the string and/or location 226 of the user as at decision module 230, transformed password validation module 232 can look for an allowed four digit transformation T′(P′) of the two-digit PIN, P, and cross reference with a record of banned four digit transformations in memory 234, before communicating results 240 of its analysis to module 216.

Upon a failure to authenticate the user by module 232, module 232 can set a flag bit 236 to indicate that only the entire, four digit PIN, P, is allowed in a next attempt from such a location. Decision module 230 can observe this bit 236 when deciding whether to enable module 232; alternatively or additionally, module 216 can observe this bit when rendering a decision based on results 240 and/or results 238. This process helps to decrease the risk of erroneous authentication by limiting an interloper to one attempt at guessing or inferring an allowed transformation. Then, if the true PIN is received, the flag bit 236 can be reset by module 212 or module 216, thus allowing module 232 to resume normal operation on the theory that the user merely committed an error.

Authentication decision rendering module 216 renders an authentication decision 250 based on results 214, results 238, and/or results 240. In some embodiments, the user is typically authenticated when any of results 214, 238, and 240 are entirely favorable. It is envisioned that further embodiments can render authentication decisions in various ways.

Now that an example has illustrated a type of transform function according to the present invention, it is possible to explore in more detail some of the characteristics of the transform function according to additional or alternative embodiments of the present invention. For example, some embodiments of the present invention use a variety of user-selectable transform functions, with each transform function having two or more sets of arguments. One of these sets can be chosen by the user at a time of enrollment. Another set can be chosen at the time of verification to generate a variety of allowable variants and to create apparent randomness. The aforementioned selection and execution of these sets of arguments can be coordinated to make detransformation by a foe observing one to many observed transformed passwords difficult.

Accordingly, it is possible to describe an overall password protection framework based on use of transform functions T( ) that are parametric functions defined as:

Pt=T (P, Preset Arguments, Free Arguments),

where:

Pt=transformed password
P=password (chosen by user when user profile is created)
Preset Arguments=set of arguments of T whose values are chosen by the user when user profile is created.
Free Arguments=set of arguments of T whose values are chosen at random by the user at verification time to confuse foe.
   Pt and P belong to the same space (e.g. space defined by strings formed of alphanumeric characters). The free arguments introduce randomness or jifter and in effect hide the original password P. The system provides a variety of user selectable transform functions so that the foe will have a very hard time in reverse engineering the transformation from transformed passwords.

Before giving a general example of the transformation function framework, the properties sought in the framework, and the rejectability characteristics, it is useful to attend to a detailed description of another technique for transforming a password.

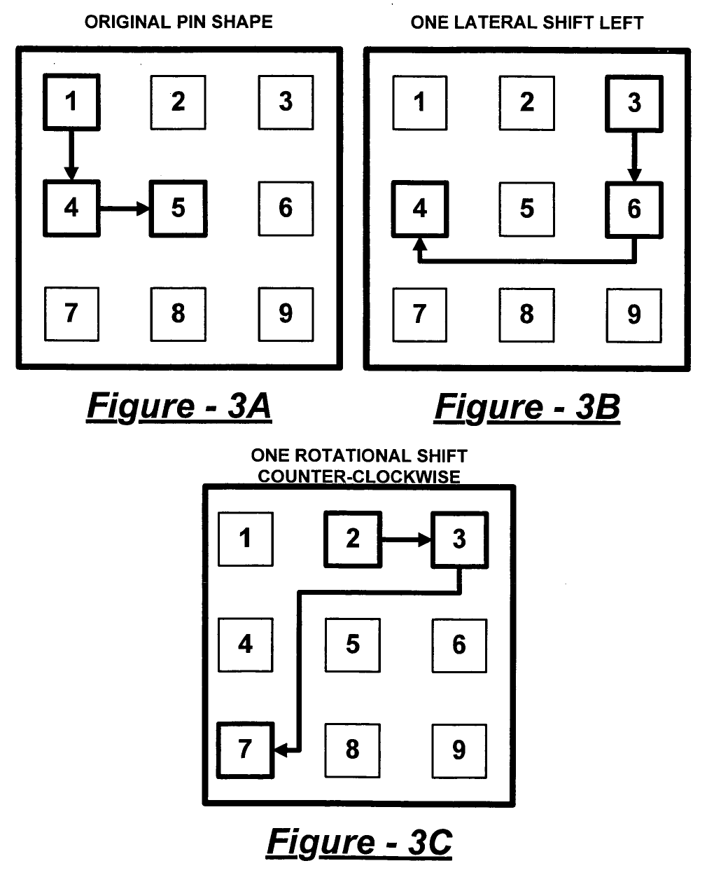

Turning now to FIGS. 3A-3C, another technique for transforming a password relates to spatial transposition of the password with respect to input components of a user interface, such as a keypad or keyboard. For example, a user of an ATM can choose or be assigned a three-digit PIN, such as ‘145’. All digits of all three-digit PINs associated with a banking institution's customers can be restricted to the digits 1-9, so as to fall within a specific region of an ATM keypad. Users can also be assigned or allowed to select a spatial transposition step and degree combination rule, and each user's individual rule can be stored in the user's profile.

As an example, consider that a user is permitted to transform their three-digit PIN in a two step spatial transposition process. First, the user can laterally shift the PIN one step in any direction selected from up, down, right, or left in the keypad region. Second, the user can rotationally shift the PIN one step clockwise or counterclockwise. In this case, there are eight possible three-digit shapes that can result.

According to the above rule, a user could shift the original PIN (FIG. 3A) one step left (FIG. 3B), and then one step counter clockwise (FIG. 3C). This process results in a different three-digit PIN, which the user can then input instead of the original PIN. There is a loss in password strength, but a gain in password protection as further explained below.

The password strength is related to the probability of a foe randomly guessing the password, which in this case is nine in seven-hundred twenty-nine, or approximately one on ninety. However, in the case where the foe has viewed the user inputting a spatially shifted version of the PIN, it is quite difficult for the foe to infer the original PIN, or any allowable transformation thereof. The difficulty is due to the fact that the foe does not know the spatial rule chosen by the user. It is envisioned that a system can provide users a few to many transformation functions. Even in the case where the foe knows the user's rule, there remains only a one in eight chance of the foe correctly inferring the PIN and arriving at another allowable transformation on the first try. Where users have individual spatial transformation combinations, and users maintain those rules in secrecy, there is little chance of a foe inferring one allowable transformation from another. If the number of digits in the PIN are increased to four, the password strength rises to one in seven-hundred twenty-nine, while the chances of a foe inferring an allowable transformation remain slim.

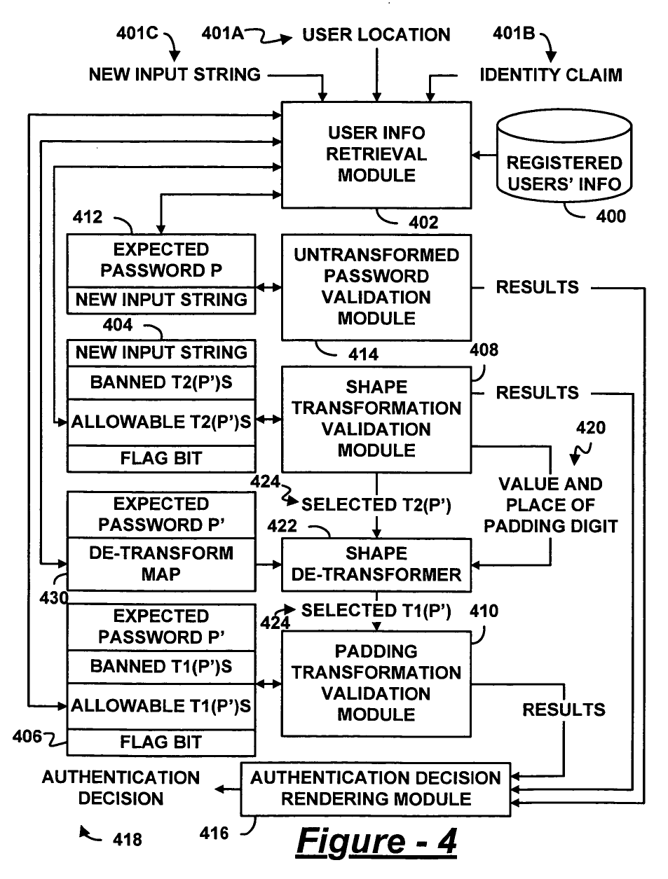

Turning now to FIG. 4, it is envisioned that multiple transformation rules can be applied sequentially by users, and validation of both transformations can be employed to authorize the user. For example, consider that a user has a four digit PIN, P, and a three-digit PIN, P′, as described above. The three-digit pin can be randomly padded with another digit selected from numbers one to nine, for a total of four digits. Consider that the user can also spatially transform the resulting four-digit PIN as described above. In some embodiments, the user can spatially transpose the three-digit pin, and then randomly pad the spatially transformed PIN as a further transformation. In other embodiments, the user needs to take care to randomly pad the three-digit PIN, and spatially transpose the padded PIN as explained below.

Since there are only up to thirty-six four-digit PINs that can result from padding the three-digit PIN, a list can be generated of the up to thirty-six allowable, four-digit, random padding transformations T1(P′)s. Similarly, since there are only eight allowable, three-digit, spatial transformations T2(P′)s, a list of these can also be generated. These lists can be stored as part of registered user's information data store 400.

When a user inputs an identity claim and a new input string corresponding to their four digit PIN, P, or transformed three-digit PIN, P′, either as T2(T1(P′)) or as T1(T2(P′)), user information retrieval module 402 can retrieve an updated list of user-specific transformation tables 404 and 406 for each rule. The information retrieved by module 402 can be determined in part based on user location 401A (which can determine input device or input mode), the identity claim 401B, and/or format and/or content of new input string 401C. Module 402 can populate the tables 404 and 406 with additional information such as the new input string and/or the expected password, P′, and communicate those tables to their respective validation modules 408 and 410.

User information retrieval module 402 can also create a table 412 containing the new input string and the expected password, P, and communicate it to untransformed password validation module 414. Module 414 can validate the four digit password, P, in the usual manner, and communicate results to authentication decision rendering module 416, which can generate an authentication decision 418 accordingly.

Shape transformation validation module 408 can use information from table 404 to determine if any of the allowable transformations are present in the new input string, and to keep track of which of the eight possible transformations are currently banned. Module 408 can also observe and set a flag bit contained in the table when a banned transformation is encountered, and observe this bit when generating results. The state of this bit can also be included in the results sent to module 416. Assuming one of the transformations is found in the new input string, module 408 can identify which digit of the string is not part of the spatially transformed three-digit PIN, P′, and communicate the value and place of this padding digit 420 in the string to shape de-transformer module 422. Module 408 can further communicate the selected spatial transformation 424 to module 422.

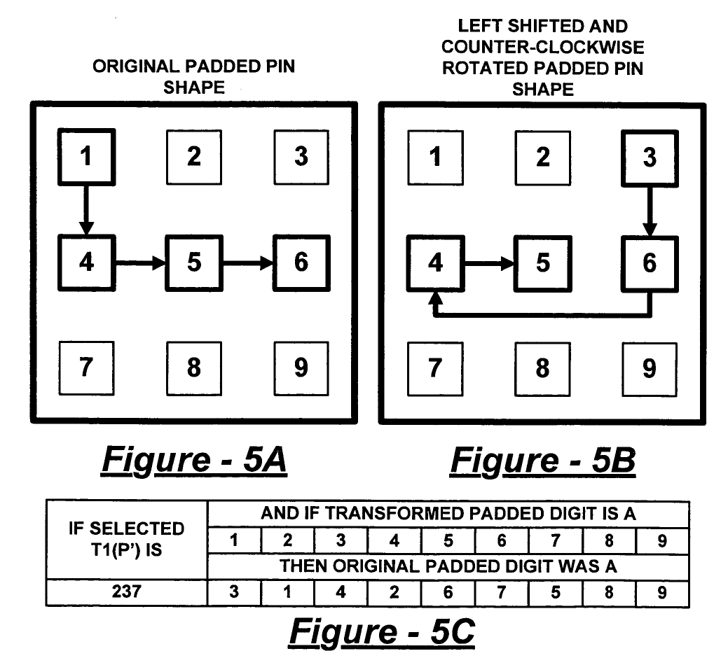

Turning now to FIGS. 5A-5C, consider the case (FIG. 5A) where the padding digit, ‘6’, is added to the end of the three-digit PIN, ‘145’, and then spatially transformed in the manner described above (FIG. 5B). If the rule for spatially transforming the PIN is known, if the spatially transformed version of the three-digit PIN is known, and if the value of the randomly added digit is known, then it is possible to predict the new value of the randomly added digit ahead of time. Accordingly, a table can be constructed (FIG. 5C) that maps a transformed value of the padding digit to its old value for each allowable spatial transformation of the three-digit PIN. This mapping table can be employed to determine the pre-spatial transformation value of the padding digit if the new value is known and the spatially transformed three-digit PIN is known.

Returning now to FIG. 4, such mapping tables can be constructed ahead of time for each user according to their spatial transformation rules. Such a table can store spatial transformation value conversions for all possible spatial transformations of that user. Accordingly, module 402 can retrieve such a mapping table 430 from data store 400 based on the identity claim 401B, and provide it to de-transformer module 422. Accordingly, module 422 has the information needed to generate the pre-transform value of the padding digit. Additionally, module 402 can populate table 430 with the expected password in the form of the three-digit PIN, P′. Since module 422 knows the place of the padding digit in the four-digit input string, and knows the three-digit PIN, module 422 can construct the original, pre-spatially transformed, padded PIN by placing the generated value in the corresponding place of the PIN, P′. This padded PIN can then be communicated to module 410 as the user-selected transformation 432.

Module 410 can employ table 406 to look for the expected password, P′, in the selected transformation 432. Alternatively, module 410 can look for the selected transformation 432 in a complete list of allowable transformations in table 406, and keep track of which transformations are currently banned. Module 410 can also observe and set a flag bit contained in the table 406 when a banned transformation is encountered, and observe this bit when generating results. The state of this bit can also be included in the results sent to module 416.

Alternatively, identification of an allowed spatial transformation at module 408 can be deemed sufficient to indicate presence of the three-digit PIN, P′, especially where the shape of the pre-spatially transformed three-digit PIN is included in the list of allowable spatial transformations. Thus, module 410 merely needs to keep track of which place and value combinations have been banned in table 406. Thus, module 422, instead of reconstructing the pre-spatially transformed, padded PIN, can communicate the place and pre-spatially transformed value of the padding digit to module 410. Then module 410 can simply compare this combination to the list of banned place and value combinations in table 406, setting and observing the flag bit accordingly as needed.

As described above, the use of shape de-transformer module 422 ensures that the user must keep track of which padding digit is used before the spatial transformation is applied, or else risk accidentally selecting the same padding digit in a subsequent attempt without knowing it. In other embodiments, shape de-transformer module 422 is eliminated, and the user is allowed to supply the padding digit after spatially transforming the three-digit pin, P′. In this case, the shape of the pre-spatially transformed three-digit PIN can be included in the list of allowable spatial transformations, and module 420 can communicate the place and value of the padding digit 420 to module 410. Then module 410 can simply compare this combination to the list of banned place and value combinations in table 406, setting and observing the flag bit accordingly as needed.

Now that some additional or alternative transformation functions have been described, it is appropriate to provide an example of the transformation function framework, its sought properties, and rejectability criterion.

### EXAMPLE

P=“145”

T=“add x random digits (D1 . . . Dx) then rotate y degrees clockwise”

Preset Arguments={x=2; y=90}

Free Arguments=D1 . . . Dx

For a given system, several to many transform functions Ti( ) will be available to the user. Each transform T can be composed of one or more basic operations (2 operations in the example above). The generated space of transformed password values is preferably large so that values of Pt are not commonly repeated.

Sought Properties:

For the user, it should be easy to generate values of Pt.
For the foe, merely observing one or many correct values of Pt should not be enough to guess the actual function Ti and its arguments. This can be done in theory using a process of elimination on the {Ti, P, Preset Arguments} tuple space. A tuple is admissible, if for all valid Pt observed so far, there exist Free Arguments such that Pt=Ti (P, Preset Arguments, Free Arguments)
For the verification system, it should be easy to verify that a given Pt is a valid input knowing the associated user profile. For that reason, reversible transform functions are preferably used to facilitate the verification (i.e., de-transformation) process (i.e., avoid pre-computed tables).
   Rejectability:
   When the level of dissimilarity between an incoming Pt and the set of active Pts in the history data store exceeds a given threshold, the incoming Pt is accepted; otherwise it is rejected.

The description of the invention is merely exemplary in nature and, thus, variations that do not depart from the gist of the invention are intended to be within the scope of the invention. For example, the padding of a password with a plurality of random inputs is a presently preferred rule for generating a plurality of user selectable passwords because it is easy for the users to implement and can produce thousands of variants. However, spatial transformations and other rules that produce less variants can also be employed, especially where banned transformations can become unbanned, and temporary transformation lockout using a flag bit or the like is employed. Still other rules for transforming passwords can be employed, such as adding one of several numbers to a PIN, selecting a password from the list of all prime numbers, or the like. Still further, passwords can be composed of letters, symbols, visemes, phonemes, allophones, or any other user input. Moreover, in some embodiments, a rule for transforming a password can be as generic as selecting a password from a pre-defined list of otherwise unrelated passwords; the password can be viewed as the entire list, and the transformation a selection of a portion of the list. Such variations are not to be regarded as a departure from the spirit and scope of the invention.

What is claimed is:

1. A user authentication system, comprising:
a transformed password validation module receiving a transformed password and generating password validation results by determining if the transformed password is allowable based on a predetermined rule for transforming a password in a plurality of ways;
a transformation assessment module receiving the transformed password and generating transformation assessment results by determining whether the transformation is at least temporarily banned by making an assessment of similarity between the transformed password and a record of at least one previously received transformed password; and
an authentication decision rendering module receiving the password validation results and the transformation assessment results, and determining whether to authenticate a user based on the password validation results and the transformation assessment results.

2. The system of claim 1, wherein the rule allows the user to transform the password by padding the password with random input.

3. The system of claim 1, wherein the rule allows the user to transform the password by spatially transposing the password with respect to input components of a user interface.

4. The system of claim 1, wherein said transformation assessment module assesses similarity between the transformed password and a previously received transformed password by aligning the transformed password with the previously received transformed password and counting a number of differences.

5. The system of claim 1, wherein said transformation assessment module is adapted to add the transformed password to the record following completion of the assessment.

6. The system of claim 1, further comprising:
a plurality of transformed password validation modules each having their own similarity assessment modules and records of previously received transformed passwords; and
a validation process selection module adapted to select one of said plurality of validation modules in accordance with predetermined criteria.

7. The system of claim 6, wherein said modules are adapted to handle transformed passwords resulting from application of different rules.

8. The system of claim 7, wherein said modules are adapted to handle transformed passwords resulting from sequential application of multiple, different rules, wherein one rule initially transforms the password, and another rule further transforms the initially transformed password.

9. The system of claim 8, further comprising a de-transformation module generating the initially transformed password by reversing a further transformation resulting from subsequent application of the other rule, and communicating the initially transformed password to a selected one of said validation modules adapted to determine whether the initially transformed password is allowable.

10. The system of claim 6, wherein said validation modules are adapted to handle transformations of different passwords registered to the user.

11. The system of claim 6, wherein said selection module is adapted to select one of said validation modules based on one or more characteristics of the transformed password.

12. The system of claim 6, wherein said selection module is adapted to select one of said validation modules based on a location of the user.

13. The system of claim 6, wherein said selection module is adapted to select one of said validation modules based on an input mode employed by the user.

14. The system of claim 1, further comprising an untransformed password validation module adapted to validate the password upon receipt thereof, thereby producing authentication results, wherein said authentication decision rendering module is adapted to receive the authentication results and determine whether to authenticate the user based on the authentication results.

15. The system of claim 14, wherein said authentication decision rendering module is adapted, upon encountering unfavorable transformation assessment results, to at least temporarily require the authentication results obtained by validation of the password for user authentication in a subsequent authentication attempt.

16. A user authentication method, comprising:
receiving a transformed password;
generating password validation results by determining if the transformed password is allowable based on a predetermined rule for transforming a password in a plurality of ways;
generating transformation assessment results by determining whether the transformation is at least temporarily banned by making an assessment of similarity between the transformed password and a record of at least one previously received transformed password; and
determining whether to authenticate a user based on the password validation results and the transformation assessment results.

17. The method of claim 16, wherein the rule allows the user to transform the password by padding the password with random input.

18. The method of claim 16, wherein the rule allows the user to transform the password by spatially transposing the password with respect to input components of a user interface.

19. The method of claim 16, further comprising assessing similarity between the transformed password and a previously received transformed password by aligning the transformed password with the previously received transformed password and counting a number of differences.

20. The method of claim 16, further comprising adding the transformed password to the record following completion of the assessment.

21. The method of claim 16, further comprising:
Employing a plurality of transformed password validation modules each having their own similarity assessment modules and records of previously received transformed passwords; and
selecting one of said plurality of validation modules in accordance with predetermined criteria.

22. The method of claim 21, wherein said modules are adapted to handle transformed passwords resulting from application of different rules.

23. The method of claim 22, wherein said modules are adapted to handle transformed passwords resulting from sequential application of multiple, different rules, wherein one rule initially transforms the password, and another rule further transforms the initially transformed password.

24. The method of claim 23, further comprising:
generating the initially transformed password by reversing a further transformation resulting from subsequent application of the other rule, and
communicating the initially transformed password to a selected one of said validation modules adapted to determine whether the initially transformed password is allowable.

25. The method of claim 21, wherein said validation modules are adapted to handle transformations of different passwords registered to the user.

26. The method of claim 21, further comprising selecting one of said validation modules based on one or more characteristics of the transformed password.

27. The method of claim 21, further comprising selecting one of said validation modules based on a location of the user.

28. The method of claim 21, further comprising selecting one of said validation modules based on an input mode employed by the user.

29. The method of claim 16, further comprising:
validating the password upon receipt thereof in an untransformed condition, thereby producing authentication results; and
determining whether to authenticate the user based on the authentication results.

30. The method of claim 29, further comprising, upon encountering unfavorable transformation assessment results, at least temporarily requiring the authentication results obtained by validating the password for user authentication in a subsequent authentication attempt.
